(19) United States
(12) Patent Application Publication
(10) Pub. No.: US 2026/0086570 A1
(43) Pub. Date: Mar. 26, 2026

(54) Drone server for environmental inspection and its operation method

(71) Applicant: Dong-A University Research Foundation For Industry-Academy Cooperation, Busan (KR)

(72) Inventor: Yong Suk KIM, Busan (KR)

(21) Appl. No.: 19/082,197

(22) Filed: Mar. 18, 2025

(30) Foreign Application Priority Data
Sep. 23, 2024 (KR) 10-2024-0128473

(51) Int. Cl. G05D 1/646; G05D 1/248; G05D 1/622; G05D 1/644; G05D 1/698; G05D 105/80; G05D 109/20; G05D 111/10; G05D 111/30

(52) U.S. Cl. CPC G05D 1/646; G05D 1/248; G05D 1/622; G05D 1/644; G05D 1/6987; G05D 2105/80; G05D 2109/20; G05D 2111/10; G05D 2111/32

(57) ABSTRACT

The present invention relates to a drone server for environmental inspection and its operation method, and more specifically, to a drone server installed in multiple environmental inspection drones, enabling them to divide and allocate their respective inspection areas, allowing each environmental inspection drone to define its inspection movement path for inspecting the assigned area, and ensuring that the environmental inspection drones move along the set paths to perform environmental inspections according to the predefined inspection movement routes. The drone server for environmental inspection which is installed in an environmental inspection drone enables the environmental inspection drone to efficiently define its inspection area, set an optimal movement path, and store movement data for improved operational accuracy.

### DESCRIPTION OF THE INVENTION

### Technical Field

The present invention relates to a drone server for environmental inspection and a method for operating the same. More specifically, the present invention pertains to a drone server installed in a plurality of environmental inspection drones, enabling them to divide and allocate their respective inspection areas. The invention allows the plurality of environmental inspection drones to set their movement paths to inspect the divided and allocated inspection areas.

Furthermore, the drones move along the set movement paths to conduct environmental inspections.

### Background Art

Recently, drones have been widely used for environmental inspection. Environmental inspection drones can rapidly collect precise data even in areas that are difficult for humans to access (e.g., mountainous regions or polluted areas, where environmental data can be safely obtained using drones). These drones can autonomously fly along pre-defined routes to collect data, reducing manpower requirements while maintaining consistency in data collection.

Moreover, they can be utilized in various environmental fields, such as measuring fine dust levels in the atmosphere, conducting water quality inspections, and monitoring soil contamination, thereby enabling more effective management of environmental issues.

Additionally, drones can be deployed in hazardous areas to collect environmental data, ensuring safety while obtaining necessary information. Furthermore, they allow for the inspection of large areas in a short period without the need for extensive manpower or equipment, making them a cost-effective alternative to traditional methods and significantly enhancing their utility value.

However, since the area that needs to be inspected for environmental monitoring is vast, a single drone alone cannot effectively monitor the entire area. Therefore, it is necessary to utilize multiple environmental inspection drones to monitor the environment. To achieve this, an integrated control method for managing multiple environmental inspection drones is essential. In other words, for a vast environmental monitoring area, multiple environmental inspection drones must divide the inspection area among themselves, set inspection movement paths to inspect their assigned areas, and conduct environmental inspections according to the designated movement paths. Additionally, an integrated and systematic control method is required, wherein the inspected environmental data is not only shared among the environmental inspection drones but also transmitted to a central control center. Furthermore, to control these multiple environmental inspection drones, a drone server installed in the drones is required. This drone server must manage and control the multiple environmental inspection drones, ensuring coordinated operations. Therefore, a drone server for environmental inspection and a method for operating the same are necessary.

### PRIOR ART DOCUMENTS

### Patent Documents

Korean Registered Patent Publication No. 10-2015189

### DESCRIPTION OF THE INVENTION

### Problem to be Solved

Accordingly, the technical problem addressed by the present invention is derived from these considerations. The objective of the present invention is to provide a drone server for environmental inspection and a method for operating the same, wherein multiple environmental inspection drones divide and allocate the inspection area and conduct inspections by systematically dividing and inspecting the designated areas.

Furthermore, the present invention aims to provide a drone server for environmental inspection and a method for operating the same, wherein the server determines the optimal inspection movement path within the divided and allocated inspection areas.

Furthermore, the present invention aims to provide a drone server for environmental inspection and a method for operating the same, wherein the server establishes the optimal inspection movement path within the divided and allocated inspection areas.

Furthermore, the present invention aims to provide a drone server for environmental inspection and a method for operating the same, wherein data collected during the environmental inspection is transmitted to and shared with a central control center.

Furthermore, the present invention provides a drone server for environmental inspection and a method for operating the same, wherein, in the event of a hazardous situation during environmental inspection, multiple environmental inspection drones collaborate to assess and respond to the hazardous situation.

Furthermore, the present invention aims to provide a drone server for environmental inspection and a method for operating the same, wherein multiple environmental inspection drones share their locations and inspection statuses with other drones.

Furthermore, the present invention provides a drone server for environmental inspection and a method for operating the same, wherein if multiple environmental inspection drones encounter obstacles while moving for environmental inspection, they avoid the obstacles and reconfigure their movement paths accordingly.

Furthermore, the present invention aims to provide a drone server for environmental inspection and a method for operating the same, wherein multiple environmental inspection drones are equipped with various sensors to inspect multiple environmental factors, such as water quality and air quality.

### Means for Solving the Problem

In order to achieve the objectives of the present invention, a drone server for environmental inspection is provided, which is installed in an environmental inspection drone and includes: an input unit for inputting external information into the server; an output unit for outputting internal information of the server to the external environment; a communication unit for communicating information between the internal and external environments of the server; a storage unit for storing information generated by the server; a sensor unit for detecting information inside and outside the server; a control unit for controlling all operations of the server; and a memory unit for executing various programs and storing associated data.

In the drone server for environmental inspection, the memory unit includes a position measurement unit for measuring the location of the environmental inspection drone, an inspection area setting unit for setting the inspection area of the environmental inspection drone, an inspection movement path setting unit for setting the inspection movement path of the environmental inspection drone, and an inspection movement path storage unit for storing the inspection movement path set by the inspection movement path setting unit.

### Effects of the Invention

According to the present invention, multiple environmental inspection drones divide and allocate the inspection area, enabling them to inspect the designated areas separately, thereby reducing the time required for environmental inspection.

Furthermore, multiple environmental inspection drones can establish optimal inspection movement paths within the divided and allocated areas, thereby reducing the time required for environmental inspection.

Furthermore, multiple environmental inspection drones can establish optimal inspection movement paths within the divided and allocated areas, minimizing battery consumption.

Furthermore, multiple environmental inspection drones can transmit and share the data collected during environmental inspection with a central control center, enabling the real-time acquisition of accurate data.

Furthermore, in the event of a hazardous situation during environmental inspection, multiple environmental inspection drones can collaborate to assess the hazardous situation, thereby improving the accuracy of the inspection.

Furthermore, multiple environmental inspection drones can share their locations and inspection statuses with other drones, thereby enhancing inspection efficiency.

Furthermore, if multiple environmental inspection drones detect obstacles while moving for environmental inspection, they can avoid the obstacles and reconfigure their movement paths, allowing for safe environmental inspection while mitigating potential hazards.

Furthermore, multiple environmental inspection drones can be equipped with various sensors to inspect different environmental factors, such as water quality and air conditions.

However, the effects of the present invention are not limited to the aforementioned advantages and may be further expanded in various ways without departing from the spirit and scope of the invention.

### BRIEF DESCRIPTION OF THE DRAWINGS

FIG. 1 is a diagram illustrating an environmental inspection drone according to an embodiment of the present invention.

FIG. 2 is a block diagram of a drone server for environmental inspection installed in an environmental inspection drone according to an embodiment of the present invention.

FIG. 3 is a diagram showing a network integration of multiple environmental inspection drones with each other or with a central control center according to an embodiment of the present invention.

FIG. 4 is a diagram illustrating how multiple environmental inspection drones set an inspection area according to an embodiment of the present invention.

FIG. 5 is a diagram showing how multiple environmental inspection drones cooperate to inspect an environmental inspection area according to an embodiment of the present invention.

FIG. 6 is a diagram illustrating how an environmental inspection drone sets the maximum area it can inspect according to an embodiment of the present invention.

FIG. 7 is an enlarged view showing a camera sensor mounted on an environmental inspection drone according to an embodiment of the present invention.

FIG. 8 is a diagram illustrating how an environmental inspection drone sets an inspection movement path within a designated environmental inspection area according to an embodiment of the present invention.

FIG. 9 is a diagram illustrating how an environmental inspection drone sets an inspection movement path in the (n+1)th inspection within a designated environmental inspection area according to an embodiment of the present invention.

FIG. 10 is a diagram illustrating how an environmental inspection drone changes an inspection point based on changes in surrounding conditions according to an embodiment of the present invention.

FIG. 11 is a diagram illustrating how an environmental inspection drone sets an inspection movement path to avoid obstacles according to an embodiment of the present

### Invention.

FIG. 12 is a detailed diagram illustrating how an environmental inspection drone sets an inspection movement path to avoid obstacles according to an embodiment of the present invention.

FIG. 13 is a diagram illustrating how a drone modifies the inspection area and inspection movement path based on the inspection progress of other drones according to an embodiment of the present invention.

FIG. 14 is a diagram illustrating how multiple drones collaborate to detect anomalies according to an embodiment of the present invention.

### DETAILED DESCRIPTION FOR IMPLEMENTING THE INVENTION

Hereinafter, preferred embodiments of the present invention will be described in more detail with reference to the accompanying drawings.

The present invention is subject to various modifications and may take on different forms. Specific embodiments are illustrated in the drawings and described in detail in the specification. However, these embodiments are not intended to limit the present invention to a particular disclosed form. Rather, it should be understood that all modifications, equivalents, and substitutions that fall within the spirit and scope of the invention are included.

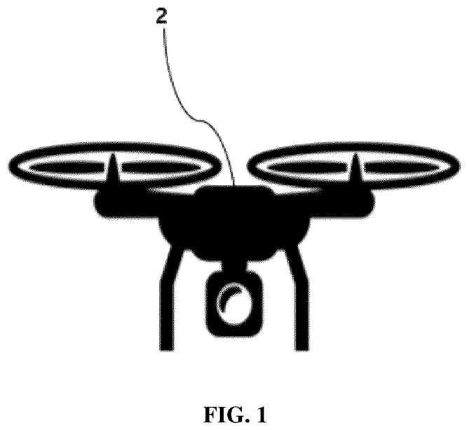

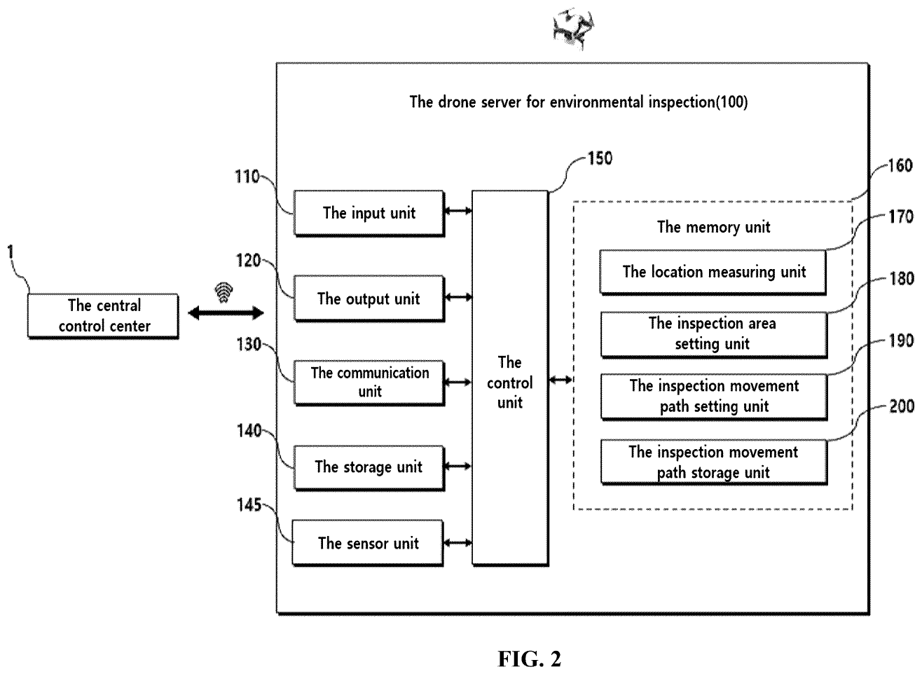

FIG. 1 is a diagram illustrating an environmental inspection drone according to an embodiment of the present invention, and FIG. 2 is a block diagram of a drone server for environmental inspection installed in an environmental inspection drone according to an embodiment of the present invention.

Referring to FIGS. 1 and 2, the drone server (100) for environmental inspection, which is installed in the environmental inspection drone (2) of the present invention, consists of an input unit (110), an output unit (120), a communication unit (130), a storage unit (140), a sensor unit (145), a control unit (150), and a memory unit (160).

The input unit (110) is responsible for receiving external information into the server. The output unit (120) is responsible for outputting internal server information to the external environment. The communication unit (130) is responsible for facilitating communication between the internal and external environments of the server. The storage unit (140) is responsible for storing server information. The sensor unit (145) detects environmental information from both inside and outside the server. The control unit (150) is responsible for controlling all operations of the server. The memory unit (160) is responsible for executing various programs and storing the associated data.

The sensor unit (145) may include a gyroscope/accelerometer sensor, which helps maintain the balance of the environmental inspection drone (2) and measures its posture during movement. The gyroscope sensor detects rotational motion, while the accelerometer sensor measures linear motion. These sensors are utilized to ensure that the environmental inspection drone (2) moves stably without tilting to one side. Additionally, the sensor unit (145) may include a compass sensor, which measures magnetic north and transmits directional information to the control unit of the environmental inspection drone (2). This sensor is incorporated into environmental inspection drones (2) equipped with GPS functionality and is used to maintain the drone's orientation. Furthermore, the sensor unit (145) may include a GPS sensor, which enables the environmental inspection drone (2) to accurately determine its location, set its movement path, and automatically return to the central control center (1) when necessary. Additionally, the sensor unit (145) may include an altitude sensor, which is used to accurately measure the height of the environmental inspection drone (2) from the ground at its current location. Additionally, the sensor unit (145) may include a camera sensor (40), which enables the environmental inspection drone (2) to capture and transmit real-time video or images. Depending on the application of the environmental inspection drone (2), various types of camera sensors (40) may be used, ranging from high-resolution cameras to infrared cameras. Furthermore, the sensor unit (145) may be equipped with a LiDAR (Light Detection and Ranging) sensor, which allows the environmental inspection drone (2) to use lasers to scan its surroundings (e.g., terrain or obstacles). The LiDAR sensor is utilized for obstacle avoidance and terrain recognition, enhancing the drone's ability to navigate complex environments.

Additionally, the sensor unit (145) may include an ultrasonic sensor, which allows the environmental inspection drone (2) to measure the distance to objects using sound waves. The ultrasonic sensor is also used to measure altitude for safe landing of the environmental inspection drone (2). Furthermore, the sensor unit (145) may be equipped with temperature and humidity sensors, which enable the environmental inspection drone (2) to monitor the surrounding temperature and humidity. The sensor unit (145) may also include wind direction and wind speed sensors, which measure the wind's direction and velocity. These sensors help the environmental inspection drone (2) adjust its movement path accordingly while in flight. Additionally, the sensor unit (145) may contain an air quality sensor, which allows the environmental inspection drone (2) to assess the quality of the atmosphere. Moreover, the sensor unit (145) may be equipped with a water quality sensor, enabling the environmental inspection drone (2) to analyze water conditions effectively.

Additionally, the memory unit (160) includes a position measurement unit (170) for determining the location of the environmental inspection drone (2), the inspection area setting unit (180) for defining the inspection area for the environmental inspection drone (2), the inspection movement path setting unit (190) for establishing the movement path for the environmental inspection drone (2) to conduct environmental inspections and the inspection movement path storage unit (200) for storing the movement path after the environmental inspection drone (2) completes its inspection along the path set by the inspection movement path setting unit (190).

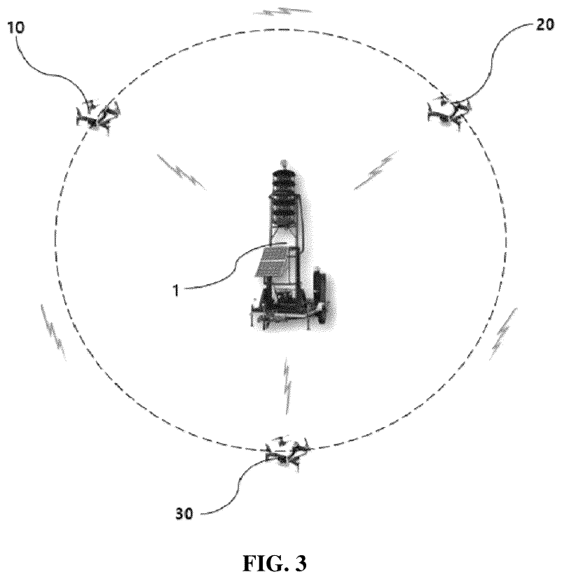

FIG. 3 is a diagram illustrating the integration of multiple environmental inspection drones into a network with each other or with a central control center according to an embodiment of the present invention.

Referring to FIG. 3, the sensor unit (145) of the drone server (100), installed in the first, second, and third environmental inspection drones (10, 20, 30), utilizes the GPS sensor and altitude sensor to measure the GPS coordinates (latitude and longitude) and altitude coordinates of the first, second, and third environmental inspection drones (10, 20, 30). The position measurement unit (170) within the memory unit (160) of the drone server (100) determines the locations of the first, second, and third environmental inspection drones (10, 20, 30) using the GPS and altitude coordinate information obtained from the sensor unit (145). Additionally, the determined locations of the first, second, and third environmental inspection drones (10, 20, 30) are shared among the environmental inspection drones (2) and are also transmitted to the central control center (1). To facilitate this process, the first, second, and third environmental inspection drones (10, 20, 30) are integrated into a network with each other and are also individually connected to the central control center (1) via a network.

The GPS sensor, included in the sensor unit (145) of the drone server (100) for environmental inspection, measures the horizontal coordinates of the environmental inspection drone (2) via satellites. The horizontal coordinates of the environmental inspection drone (2) are represented in terms of latitude and longitude, allowing the precise determination of its location on Earth. For example, in the case of the first environmental inspection drone (10), its location may be measured and recorded as latitude 37.7749° N, longitude 122.4194° W.

The altitude sensor, included in the sensor unit (145), measures the altitude of the environmental inspection drone (2). The altitude sensor determines how high the environmental inspection drone (2) is from the ground surface by either detecting changes in atmospheric pressure or using laser-based distance measurements relative to the surface. For example, if the first environmental inspection drone (10) is flying at a height of 150 meters, the altitude sensor can display the altitude coordinates as ‘Altitude: 150 meters’.

The location information determined by the position measurement unit (170) of the first, second, and third environmental inspection drones (10, 20, 30) is shared among these drones and transmitted to the central control center (1) for further sharing. This allows the specific locations of the first, second, and third environmental inspection drones (10, 20, 30) to be monitored in real-time.

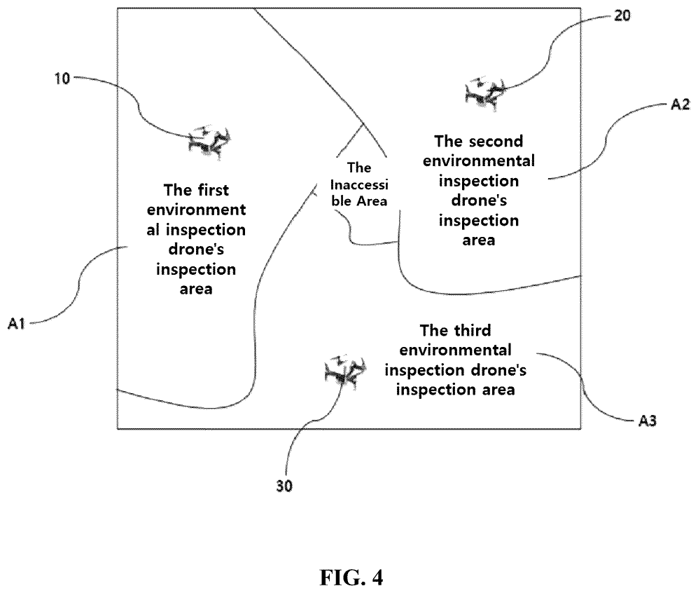

FIG. 4 is a diagram illustrating how multiple environmental inspection drones set the environmental inspection area according to an embodiment of the present invention.

Referring to FIG. 4, the first environmental inspection drone (10), second environmental inspection drone (20), and third environmental inspection drone (30) each define their respective inspection areas. The inspection area setting unit (180) within the memory unit (160) of each first, second, and third environmental inspection drone (10, 20, 30) determines its own inspection area by considering various factors, including battery status, surrounding terrain conditions, nearby obstacles, weather conditions, and the inspection areas already assigned to other environmental inspection drones (2).

Additionally, the first environmental inspection drone (10), second environmental inspection drone (20), and third environmental inspection drone (30) sequentially determine their respective inspection areas. The first environmental inspection drone (10) is the first to set its inspection area, taking into account factors such as battery status, surrounding terrain conditions, nearby obstacles, and weather conditions. Specifically, the first environmental inspection drone (10) checks its battery status to determine its available flight time, analyzes the surrounding terrain, detects nearby obstacles, and evaluates the weather conditions to define its inspection area safely and efficiently.

The first environmental inspection drone (10) checks its battery status to determine its maximum flight duration. Based on this maximum flight duration, it calculates the round-trip time required to safely return to its designated return point, thereby determining the available inspection time. Using the available inspection time and the movement speed of the first environmental inspection drone (10), it calculates the maximum possible travel distance, which is then set as the maximum movement radius. Additionally, a three-dimensional virtual sphere is formed based on the maximum movement radius, and this sphere-shaped area is set as the initial environmental inspection area for the first environmental inspection drone (10).

For example, if the first environmental inspection drone (10) has 80% battery remaining, it calculates its battery consumption rate per hour and determines that the maximum flight duration is 20 minutes. Out of this, it allocates 10 minutes for environmental inspection and reserves the remaining 10 minutes for returning to the designated return point. Based on the 10-minute inspection time, the first environmental inspection drone (10) calculates the maximum possible travel distance by considering its movement speed. If the drone moves at a speed of 100 meters per minute, it can travel a maximum of 1 km in 10 minutes. Consequently, it sets 1 km as the maximum travel distance and defines it as the maximum movement radius. Furthermore, using the 1 km maximum movement radius, the drone forms a three-dimensional virtual sphere and sets this spherical area as the initial environmental inspection area for the first environmental inspection drone (10).

The first environmental inspection drone (10), after setting its initial environmental inspection area, adjusts the area by considering surrounding terrain conditions, nearby obstacles, and weather conditions.

First, the first environmental inspection drone (10) assesses the surrounding terrain conditions. Based on this assessment, it modifies the initial environmental inspection area accordingly. For example, if the initial environmental inspection area includes hazardous regions such as cliffs, steep slopes, or rugged mountainous areas, the first environmental inspection drone (10) excludes these regions from its designated inspection area to ensure safe and efficient operation.

Additionally, the first environmental inspection drone (10) may exclude inspection areas that fall above or below a certain altitude threshold within the initial environmental inspection area. For example, if the surrounding terrain consists of flat landscapes such as coastal or plain regions, the first environmental inspection drone (10) can conduct inspections at a low altitude. In this case, it excludes high-altitude areas from the initial environmental inspection area. Conversely, if the surrounding terrain includes dense forests, sand dunes, or other elevated features, the first environmental inspection drone (10) must perform inspections from a higher altitude. Therefore, it excludes low-altitude areas from the initial environmental inspection area to optimize inspection efficiency.

The first environmental inspection drone (10), after setting its initial environmental inspection area, assesses the surrounding terrain conditions and adjusts the initial environmental inspection area accordingly. Additionally, it evaluates the nearby obstacles and makes further adjustments based on the identified obstacles. For example, if the first environmental inspection drone (10) detects obstacles such as mountains, rocks, large trees, or buildings, it excludes the areas containing these obstacles from the initial environmental inspection area to ensure safe and effective inspection operations.

The first environmental inspection drone (10) further adjusts the initial environmental inspection area by evaluating the surrounding weather conditions. For example, areas experiencing heavy rainfall, thunderstorms, lightning, or strong winds are excluded from the initial environmental inspection area to ensure safe and stable drone operation.

Through this process, the first environmental inspection drone (10) further adjusts the initial environmental inspection area by considering factors such as surrounding terrain conditions, nearby obstacles, and weather conditions. As a result, it finalizes the first environmental inspection drone's inspection area (A1), which will be used for conducting the environmental inspection.

Once the first environmental inspection drone's inspection area (A1) is finalized, the second environmental inspection drone (20) proceeds to define its own environmental inspection area. During this process, the second environmental inspection drone (20) excludes the first environmental inspection drone's inspection area (A1) and, using the same method as the first environmental inspection drone (10), determines its designated second environmental inspection drone inspection area (A2). After the second environmental inspection drone (20) sets its inspection area (A2), the third environmental inspection drone (30) follows the same procedure. It excludes the areas designated by both the first (10) and second (20) environmental inspection drones, and then, using the same method as the previous drones, determines its own third environmental inspection drone inspection area (A3).

Meanwhile, if the first environmental inspection drone (10) detects environmental changes (e.g., changes in weather conditions) while moving within its predefined inspection area (A1), it can modify the designated inspection area (A1) accordingly. For example, if strong winds or heavy rainfall previously led to the exclusion of certain areas from the first environmental inspection drone's inspection area (A1), the drone may re-include those areas in A1 once the wind weakens or the rainfall decreases, thereby dynamically adjusting its inspection area (A1).

As the first environmental inspection drone (10) modifies its inspection area (A1) in response to environmental changes, the second environmental inspection drone (20) and third environmental inspection drone (30) also adjust their respective inspection areas (A2) and (A3) accordingly.

Additionally, if the second environmental inspection drone (20) modifies its inspection area (A2) in response to environmental changes, the first environmental inspection drone (10) and third environmental inspection drone (30) may also adjust their respective inspection areas (A1) and (A3) accordingly. Similarly, if the third environmental inspection drone (30) changes its inspection area (A3) due to environmental changes, the first environmental inspection drone (10) and second environmental inspection drone (20) may also modify their respective inspection areas (A1) and (A2) to adapt to the updated inspection conditions.

Additionally, the first, second, and third environmental inspection drones (10, 20, 30) do not perform a single environmental inspection and then terminate their operations; rather, they conduct repeated inspections at predetermined time intervals. The inspection areas for these repeated environmental inspections may also be adjusted in response to changes in environmental conditions. The first, second, and third environmental inspection drones (10, 20, 30), after completing the (n)th environmental inspection, modify their inspection areas before starting the (n+1)th inspection if environmental changes occur (e.g., changes in weather conditions).

For example, if a strong wind area was excluded from the first environmental inspection drone's inspection area (A1) during the (n)th inspection, but the wind weakens before the (n+1)th inspection, the previously excluded area may be re-included in A1. As a result, the second environmental inspection drone's inspection area (A2) and the third environmental inspection drone's inspection area (A3) may also be adjusted accordingly. Similarly, if an obstacle area was excluded from the second environmental inspection drone's inspection area (A2) during the (n)th inspection but the obstacle is removed before the (n+1)th inspection, the excluded area may be added back to A2. Consequently, the first (A1) and third (A3) inspection areas may also be modified to accommodate the changes. Additionally, if an area with numerous buildings was excluded from the third environmental inspection drone's inspection area (A3) during the (n)th inspection but the buildings have been removed before the (n+1)th inspection, that area may be re-included in A3. This modification, in turn, may lead to adjustments in the first (A1) and second (A2) inspection areas as well.

Additionally, even after the first, second, and third environmental inspection drones (10, 20, 30) have designated their respective inspection areas, there may still be unassigned inspection areas that were not included due to drone inaccessibility. In such cases, the central control center (1) can designate the most accessible environmental inspection drone among the first, second, or third environmental inspection drones (10, 20, 30) to inspect the previously unassigned area.

That is, the central control center (1) continuously monitors the inspection areas assigned to the first, second, and third environmental inspection drones (10, 20, 30) and detects any unassigned areas (i.e., areas that are inaccessible to the drones). When such unassigned areas are identified, the central control center (1) evaluates the current positions, battery status, surrounding terrain, nearby obstacles, and weather conditions of the drones to determine which drone is best suited to access the unassigned area. Based on this assessment, the central control center (1) selects the most accessible drone among the first, second, or third environmental inspection drones (10, 20, 30) and assigns it to inspect the previously uncovered area. Through this approach, all inspection areas can be covered, ensuring a complete and thorough inspection without any missing regions. To facilitate this process, real-time data sharing is established between the first, second, and third environmental inspection drones (10, 20, 30) and the central control center (1), enabling continuous updates on location, battery status, terrain conditions, obstacles, and weather conditions.

Additionally, the central control center (1) can designate the environmental inspection drone that is closest to an unassigned inspection area (an area inaccessible to the environmental inspection drones) or the drone with the longest operational time among the first, second, and third environmental inspection drones (10, 20, 30) to inspect the designated area.

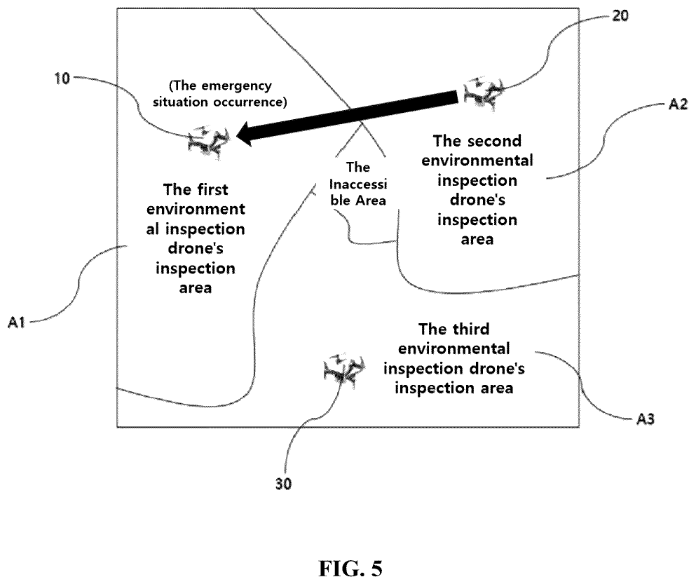

FIG. 5 is a diagram illustrating how multiple environmental inspection drones cooperate to inspect an environmental inspection area according to an embodiment of the present invention. Referring to FIG. 5, the first, second, and third environmental inspection drones (10, 20, 30) share their current status (e.g., battery status, malfunction occurrences, etc.) with other environmental inspection drones and the central control center (1). This enables them to adjust their cooperative relationships in real time based on emergency situations, allowing for an effective response to such situations.

For example, if the first environmental inspection drone (10) encounters an abnormal battery issue during an inspection, causing rapid battery depletion that prevents it from completing the remaining inspection tasks, or if the first environmental inspection drone (10) malfunctions and is no longer able to perform environmental inspections, the central control center (1) can designate one of the second or third environmental inspection drones (20, 30) to take over the task. For instance, the central control center (1) may select the environmental inspection drone that is closest to the first environmental inspection drone (10) and direct it to move into the first environmental inspection drone's inspection area (A1), allowing it to continue and complete the inspection tasks previously assigned to the first environmental inspection drone (10).

In this case, the environmental inspection drone that takes over the inspection tasks of the first environmental inspection drone (10) will exclude the areas that have already been inspected by the first environmental inspection drone (10) and will only inspect the remaining uninspected areas. This prevents unnecessary reinspection of completed inspection areas. For example, if the first environmental inspection drone (10) has already inspected the southern region of its assigned area, the drone taking over the inspection task will proceed to inspect the northern region instead.

Additionally, if an emergency situation occurs, the first environmental inspection drone (10) can switch to safe mode and transition to a return-to-home (RTH) flight mode, allowing it to return to its initial departure point. Furthermore, the first environmental inspection drone (10) notifies the central control center (1) of the emergency situation. If necessary, the central control center (1) can remotely control the first environmental inspection drone (10) to ensure its safe return to the initial departure point.

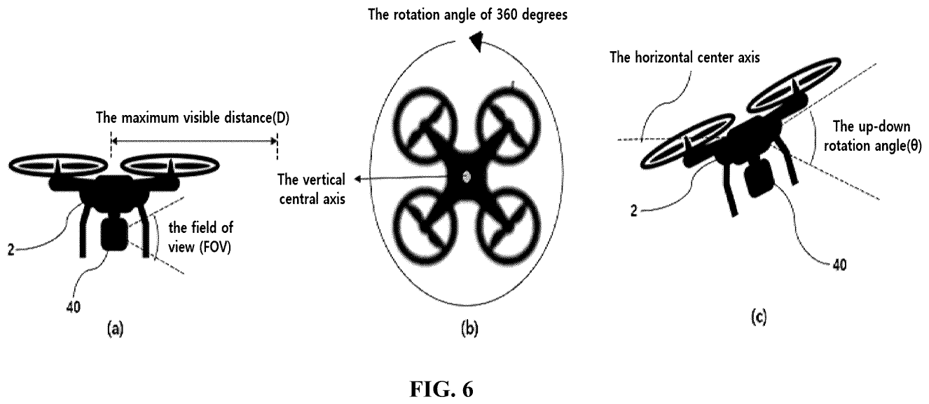

FIG. 6 is a diagram illustrating the process of setting the maximum inspection area that an environmental inspection drone can inspect, according to an embodiment of the present invention.

Referring to FIG. 6, once the environmental inspection drone (2) defines its designated inspection area, it then establishes an inspection path to conduct the inspection. Before setting the inspection path, however, the inspection area setting unit (180) first determines the maximum inspection area that the environmental inspection drone (2) can cover from its current location.

In determining the maximum inspection area that the environmental inspection drone (2) can cover from its current location, various factors are considered, including the field of view (FOV) of the camera sensor (40), the maximum visible distance (D), the rotation angle based on the vertical central axis of the environmental inspection drone (2), and the tilt angle (θ) based on the horizontal central axis of the environmental inspection drone (2) for upward and downward rotation.

The inspection area setting unit (180) of the environmental inspection drone (2) first sets the maximum inspection area that can be inspected at the location of the environmental inspection drone (2) by utilizing the angle of view (α) and maximum visible distance (D) of the camera sensor (40) equipped on the environmental inspection drone (2) as shown in (a) of FIG. 6, the rotation angle of 360 degrees based on the vertical center axis of the environmental inspection drone (2) as shown in (b) of FIG. 6, and the up-down rotation angle (θ) based on the horizontal center axis of the environmental inspection drone (2) as shown in (c) of FIG. 6.

The angle of view (α) of the camera sensor (40) indicates the range of the field of view that the camera sensor (40) can capture at one time. This varies depending on the lens design of the camera (40) and is measured horizontally and vertically, respectively. For example, if the angle of view of the camera sensor (40) of a specific environmental inspection drone (2) is 39.5 degrees horizontally and 27 degrees vertically, when the environmental inspection drone (2) photographs from a height of 150 m, it can photograph 108 m horizontally and 72 m vertically on the ground.

The maximum visible distance (D) of the camera sensor (40) is the maximum distance at which the camera sensor (40) can identify a specific object or point, and is determined by the focal length of the lens, sensor resolution, aperture, sensor size, noise, and signal processing capability.

The environmental inspection drone (2) can rotate 360 degrees around the vertical central axis. As the environmental inspection drone (2) rotates 360 degrees around the vertical central axis, the camera sensor (40) equipped on the environmental inspection drone (2) also rotates 360 degrees around the vertical central axis, thereby expanding the environmental area that the camera sensor (40) can inspect. The camera sensor (40) can rotate 360 degrees around the current location of the environmental inspection drone (2) and perform environmental inspection work from various angles. In addition, if the environmental inspection drone (2) completes the environmental inspection at the current location, it moves to the next inspection location, rotates 360 degrees again, and performs the environmental inspection work.

The environmental inspection drone (2) rotates up and down by the vertical rotation angle (θ) based on the horizontal center axis. As the environmental inspection drone (2) rotates up and down by the vertical rotation angle (θ), the field of view of the camera sensor (40) for environmental inspection can be expanded up and down from the field of view of the existing camera sensor (40) by the vertical rotation angle (θ) of the environmental inspection drone (2).

Through this, the environmental inspection area that can be inspected by the environmental inspection drone (2) can be expanded.

The inspection area setting unit (180) of the environmental inspection drone (2) can set the maximum inspectionable area at a specific point for environmental inspection by utilizing the angle of view (α) of the camera sensor (40) at a specific point where the environmental inspection drone (2) is located, the maximum visible distance (D) of the camera sensor (40), the 360-degree rotation angle based on the vertical center axis of the environmental inspection drone (2), and the up-down rotation angle (θ) based on the horizontal center axis of the environmental inspection drone (2).

That is, at a specific point where the environmental inspection drone (2) is located, the environmental inspection drone (2) rotates 360 degrees at a preset angle interval based on the vertical center axis, and the environmental inspection drone (2) rotates up and down as much as possible based on the horizontal center axis, and the field of view that can be secured through the camera sensor (40) up to the maximum visible distance of the camera sensor (40) can be set as the maximum inspectionable area.

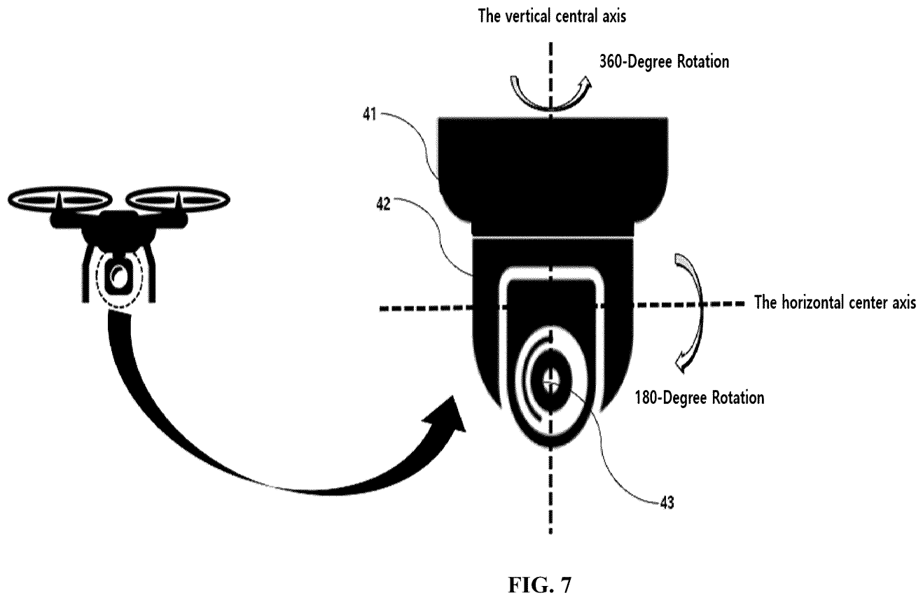

FIG. 7 is an enlarged view showing a camera sensor equipped on an environmental inspection drone according to an embodiment of the present invention.

Referring to FIG. 7, the camera sensor (40) equipped on an environmental inspection drone (2) is composed of a first support part (41), a second support part (42), and a lens part (43). The first support member (41) is fixed to the environmental inspection drone (2) and supports the camera sensor (40), and the second support member (42) includes the lens member (43) inside and is connected to the first support member (41). In addition, the second support member (42) can rotate around the vertical central axis and rotate 360 degrees, and the lens member (43) can rotate around the horizontal central axis and rotate 180 degrees.

The second support member (42) rotating 360 degrees around the vertical central axis has the same effect as the environmental inspection drone (2) described in FIG. 6 rotating 360 degrees around the vertical central axis, so that when setting the maximum inspection area, one of the two methods can be selected to set the maximum inspection area.

In addition, the field of view of the camera sensor (40) can be further expanded by rotating 180 degrees based on the horizontal central axis of the lens unit (43). That is, in the field of view that can be secured through the camera sensor (40) described in FIG. 6, the field of view that can be secured through the camera sensor (40) is further expanded by rotating the lens unit (43) 180 degrees based on the horizontal central axis, and accordingly, the maximum inspection area that can be set by the environmental inspection drone (2) at the point where the environmental inspection drone (2) is located is further expanded.

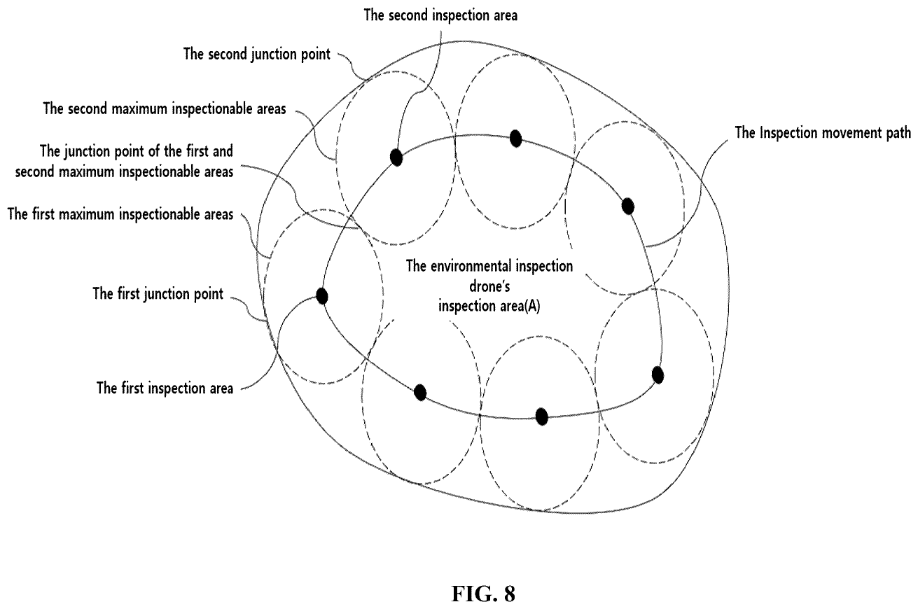

FIG. 8 is a drawing showing an environmental inspection drone according to an embodiment of the present invention setting an inspection movement path to conduct an inspection within a set environmental inspection area.

Referring to FIG. 8, when the environmental inspection drone (2) sets its own inspection area (A) by considering its own battery status, surrounding terrain status, surrounding obstacle status, or surrounding weather status, and the set inspection area of another environmental inspection drone (2), as described in FIG. 4, the environmental inspection drone (2) sets an inspection movement path to move for environmental inspection within the set inspection area (A). At this time, the environmental inspection drone (2) sets an inspection movement path by utilizing the maximum inspectionable area of the environmental inspection drone (2) described in FIG. 6 and FIG. 7.

In one embodiment of the present invention, when an inspection area (A) to be inspected by the environmental inspection drone (2) is set, the inspection movement path setting unit (190) of the environmental inspection drone (2) sets an inspection movement path for environmental inspection.

The center point of an imaginary circle (in the case of two dimensions) or sphere (in the case of three dimensions) formed by connecting the first junction point where the outermost point of the first maximum inspection area and the outermost point of the inspection area (A) are joined to each other and the junction point of the first and second maximum inspection areas where the outermost point of the first maximum inspection area and the outermost point of the second maximum inspection area are joined is set as the first inspection point.

In addition, the inspection movement path setting unit (190) sets the center point of a virtual circle (in the case of two dimensions) or sphere (in the case of three dimensions) formed by connecting the second junction point where the outermost point of the second maximum inspectionable area and the outermost point of the inspection area (A) are joined to each other and the junction point of the first and second maximum inspectionable areas where the outermost point of the first maximum inspectionable area and the outermost point of the second maximum inspectionable area are joined to the second inspection point.

Thereafter, the inspection movement path setting unit (190) sets inspection points sequentially in the same manner as the first and second inspection points are set, and connects the sequentially set inspection points to set an inspection movement path. The environmental inspection drone (2) moves along the set inspection movement path, and when it arrives at an environmental inspection point, it conducts an environmental inspection, and when it completes the environmental inspection work at the corresponding environmental inspection point, it moves to the next environmental inspection point and continues the environmental inspection.

The environmental inspection drone (2) moves along a set inspection movement path, and when the environmental inspection task is completed at all inspection points within the inspection movement path, the nth inspection is terminated and the n+1th inspection is performed.

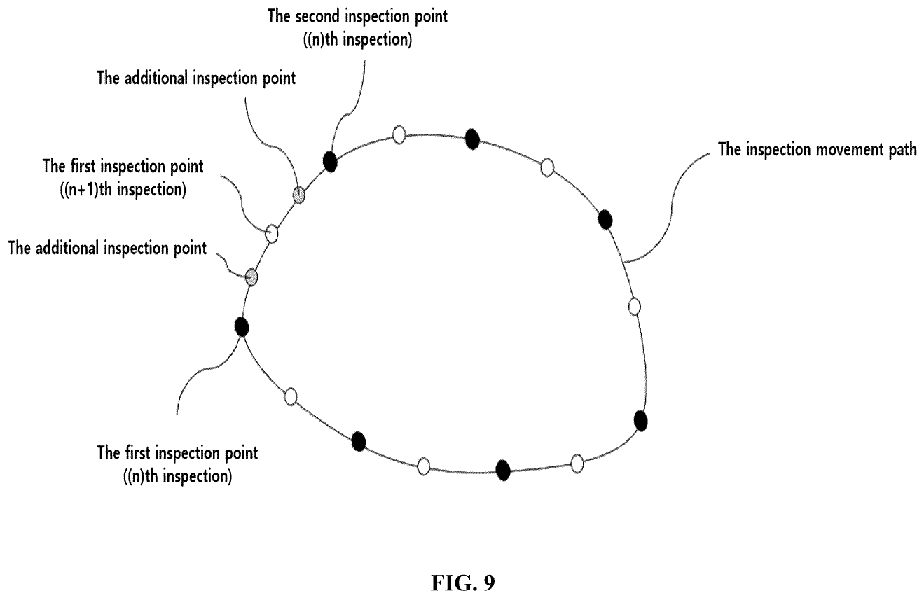

FIG. 9 is a drawing showing that an environmental inspection drone sets an inspection movement path in the (n+1)th inspection to conduct an inspection within a set environmental inspection area according to an embodiment of the present invention.

Referring to FIG. 9, the environmental inspection drone (2) performs an environmental inspection task while moving along an inspection movement path set by the inspection movement path setting unit (190) in the nth inspection. The environmental inspection drone (2) repeatedly performs an environmental inspection task, and after completing the nth inspection task, performs the n+1th inspection task.

After completing the nth inspection and before performing the (n+1)th inspection task, the movement path setting unit (190) can reset the inspection points. Through this, the areas that are excluded and not inspected within the inspection area (A) can be minimized. The movement path setting unit (190) can set the midpoint between adjacent inspection points where the environmental inspection was performed in the (n)th inspection in the (n+1)th inspection task as a new inspection point.

For example, in the nth inspection, the midpoint between the first inspection point and the second inspection point set as the inspection point can be set as a new first inspection point in the n+1th inspection. The movement path setting unit (190) sets the midpoint between adjacent inspection points as a new inspection point in the same manner as described above, thereby finally confirming all n+1th inspection points. The environmental inspection drone (2) sequentially moves to the newly set inspection points of the inspection movement path and performs the (n+1)th inspection task.

In addition, after the (n+1)th inspection task is completed, the (n+2)nd inspection task can be performed while moving the inspection point where the inspection task was performed in the nth inspection task in the same manner, and the (n+3)rd inspection task can be performed while moving the inspection point where the inspection task was performed in the (n+1)st inspection task in the same manner. In the subsequent inspection tasks, the inspection tasks can be repeatedly performed while alternating the inspection point of the nth inspection task and the inspection point of the (n+1)th inspection task in the same manner as above.

Meanwhile, the movement path setting unit (190) can additionally set an inspection point according to changes in the surrounding conditions of the environmental inspection drone (2). For example, if the air pollution around the environmental inspection drone (2) becomes severe (as determined by the control unit (150) based on data measured by the sensor unit (145), the movement path setting unit (190) can additionally set an inspection point. At this time, the movement path setting unit (190) can set a newly added inspection point at a midpoint between the inspection point of the adjacent nth inspection and the inspection point of the (n+1)th inspection. In addition, additional inspection points can be set at the midpoint of the inspection point of the (n)th inspection adjacent to the added inspection point, and at the midpoint of the inspection point of the (n+1)th inspection adjacent to the added inspection point. Through this, when the environmental inspection drone (2) needs to perform environmental inspection work more precisely (e.g., when the surrounding air pollution becomes severe), the environmental inspection work can be performed more precisely.

In addition, the inspection movement path and inspection points for environmental inspection set in the movement path setting unit (190) are all stored in the inspection movement path storage unit (200) and are reused when the environmental inspection drone (2) sets the inspection movement path for environmental inspection.

In addition, the environmental inspection drone (2) shares all of the work status of the environmental inspection drone (2) moving along the set inspection movement path and inspecting the environment with the central control center (1) in real time. Through this, the central control center (1) can identify all of the inspection movement path, inspection points, inspection completed areas, and inspection incomplete areas of the environmental inspection drone (2), and if there is an area that remains as an incomplete area even after the environmental inspection drone (2) has performed a preset number of repetitive tasks for repetitive environmental inspections, the central control center (1) can move the environmental inspection drone (2) to that area to perform the environmental inspection task. Through this, the environmental inspection drone (2) can be made to perform environmental inspections without omission in all areas of the set inspection area.

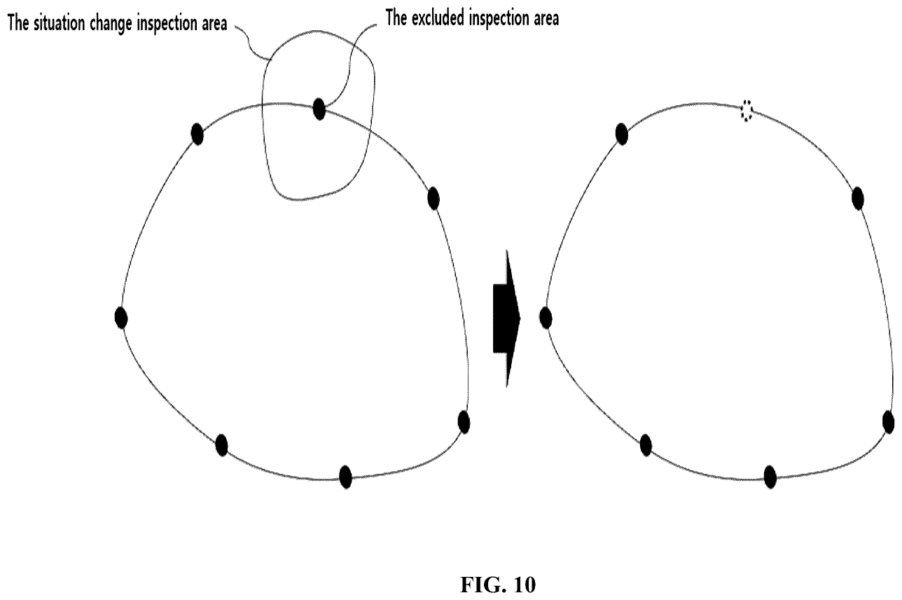

FIG. 10 is a drawing showing an environmental inspection drone according to one embodiment of the present invention and changing the inspection point according to changes in the surrounding circumstances thereof.

Referring to FIG. 10, while the environmental inspection drone (2) is conducting an environmental inspection along a moving path, it may move directly to the next inspection point without conducting an environmental inspection at a specific inspection point according to changes in the environmental inspection drone (2) and its surrounding circumstances.

For example, when the environmental inspection drone (2) is moving along an inspection path for environmental inspection, if it determines that the battery is not sufficient for environmental inspection in a situation change inspection area, it moves directly to the next inspection point without performing an environmental inspection at the inspection point included in the situation change inspection area.

In addition, if the environmental inspection drone (2) encounters a situation of rapid weather change such as turbulence or rain showers while moving along the inspection movement path for environmental inspection in the situation change inspection area, it determines that environmental inspection is impossible and does not perform environmental inspection at the inspection point included in the situation change inspection area and moves directly to the next inspection point.

For example, the environmental inspection drone (2) continuously monitors the battery status during the mission, and when the battery level falls below a threshold, the inspection movement path setting unit (190) modifies the current path of the environmental inspection drone (2) to move to the nearest charging point. For example, when the battery level of the environmental inspection drone (2) falls below 20% during the flight, the inspection movement path setting unit (180) calculates the shortest path to the charging station and starts the movement of the environmental inspection drone (2), and when charging is completed, it returns to the previous inspection location and resumes the mission.

In addition, the environmental inspection drone (2) scans and analyzes the surrounding terrain in real time using sensors such as radar, LiDAR, and cameras, and when an obstacle is discovered, the inspection movement path setting unit (190) modifies the path to avoid it. For example, when the environmental inspection drone (2) discovers a tall tree while flying over mountainous terrain, the inspection movement path setting unit (190) recognizes this and adjusts the altitude to modify the path to avoid the tree.

In addition, the environmental inspection drone (2) monitors weather changes in real time during the flight based on weather detection sensors and weather data. For example, if a strong wind is detected during the flight, the inspection movement path setting unit (190) of the environmental inspection drone (2) analyzes the wind strength and direction to re-set a safe flight path, and if necessary, lands in a safe location or adjusts the flight altitude.

In addition, when multiple environmental inspection drones (2) perform work simultaneously, each environmental inspection drone (2) shares its location and path with each other in real time. This adjusts the path to avoid collision and increase inspection efficiency. For example, when multiple environmental inspection drones (2) inspect the edge area of the inspection area they are inspecting, each environmental inspection drone (2) checks the location of other environmental inspection drones (2) and the distance between environmental inspection drones (2) to avoid collision and proceed with the inspection.

Meanwhile, the environmental inspection drone (2) moves along the inspection movement path set by the inspection movement path setting unit (190) to inspect the environment, and collects environmental data using a high-resolution camera sensor, LIDAR sensor, ultrasonic sensor, etc. equipped with the sensor unit (145). For example, the environmental inspection drone (2) flies over a forest and collects the location and height of trees, terrain ups and downs, obstacle locations, and dangerous areas. In addition, the data collected by the environmental inspection drone (2) is transmitted to the central control center (1).

The central control center (1) receives the data collected by the environmental inspection drone (2) and analyzes it to create a 3D map. As the number of inspections by the environmental inspection drone (2) increases, the data transmitted by the environmental inspection drone (2) to the central control center (1) increases, and accordingly, the 3D map created by the central control center (1) is continuously updated and becomes more sophisticated.

The inspection movement path setting unit (190) of the environmental inspection drone (2) sets the inspection movement path based on the updated 3D map. When the inspection movement path setting unit (190) sets the movement path, an artificial intelligence-based inspection movement path setting algorithm can be utilized. The artificial intelligence-based inspection movement path setting algorithm calculates the optimal movement path based on the previous movement path of the environmental inspection drone (2) and the updated 3D map.

The AI-based inspection movement path setting algorithm resets the path in real time when it detects a change in the new environment or an obstacle. For example, if the environmental inspection drone (2) discovers that a tree has grown on the previously moved path, it searches for and sets a new path to avoid it.

If the environmental inspection drone (2) detects a new obstacle while moving, it corrects its path in real time. The environmental inspection drone (2) utilizes a high-resolution camera sensor, a LIDAR sensor, an ultrasonic sensor, etc., equipped with a sensor unit (145) to correct its path in real time. The sensor unit (145) includes a high-resolution camera sensor, a LIDAR sensor, an ultrasonic sensor, etc., to scan the moving environment in which the environmental inspection drone (2) moves, and if it detects a new obstacle while moving, the inspection movement path setting unit (180) immediately calculates a new path that can be flown safely using an artificial intelligence-based inspection movement path setting algorithm and applies it to correct the movement path of the environmental inspection drone (2).

For example, the environmental inspection drone (2) determines whether it can reach the first destination along the first movement path by considering the current movement conditions (remaining battery level, weather conditions, obstacles, etc.). For example, if the battery is insufficient or an obstacle occurs on the path, it determines that it cannot reach. If the environmental inspection drone (2) cannot reach the first destination, the environmental inspection drone (2) searches for a second movement path and evaluates whether it can reach the first destination through the second movement path. If it can reach the first destination using the second movement path, the environmental inspection drone (2) sets that path as an emergency movement path. In addition, even if it can reach the first destination using a part of the second movement path, the environmental inspection drone (2) sets an emergency movement path along that path.

In addition, the environmental inspection drone (2) determines whether it can reach the first destination along the first movement path by considering the current movement conditions (remaining battery level, weather conditions, obstacles, etc.). For example, if an obstacle occurs on the first movement path, the environmental inspection drone (2) determines that it cannot reach the first destination. If the environmental inspection drone (2) cannot reach the first destination due to the obstacle, the environmental inspection drone (2) searches for a second movement path that avoids the obstacle and deviates the least from the first movement path, and sets that path as an emergency movement path. In addition, the environmental inspection drone (2) moves along the second movement path to avoid the obstacle, and if it avoids the obstacle, it returns to the first movement path and moves along the first movement path to the first destination.

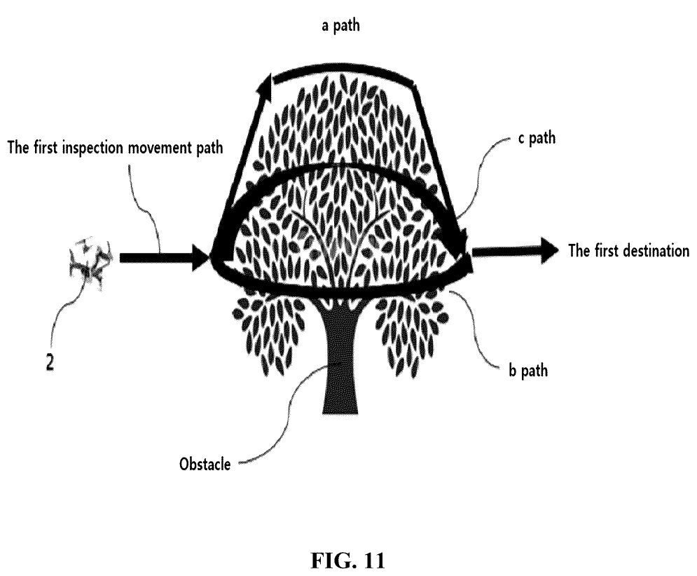

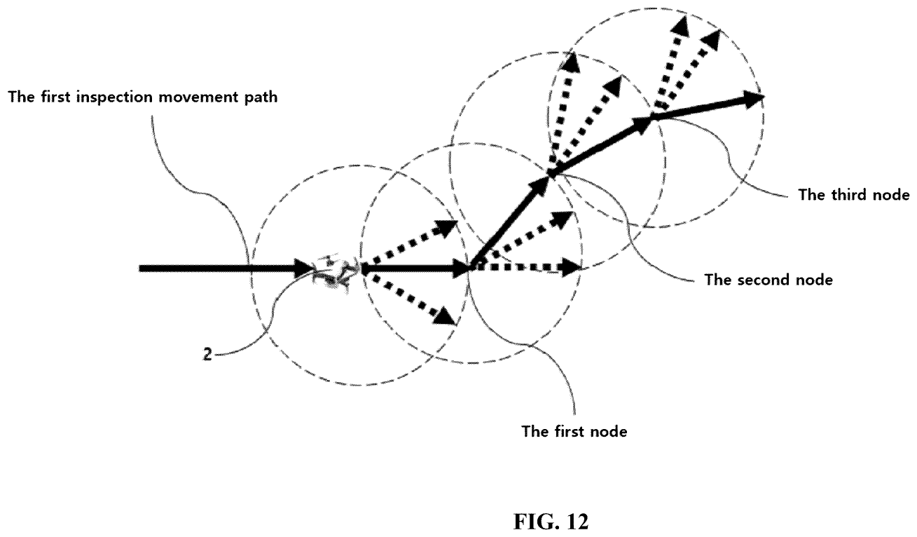

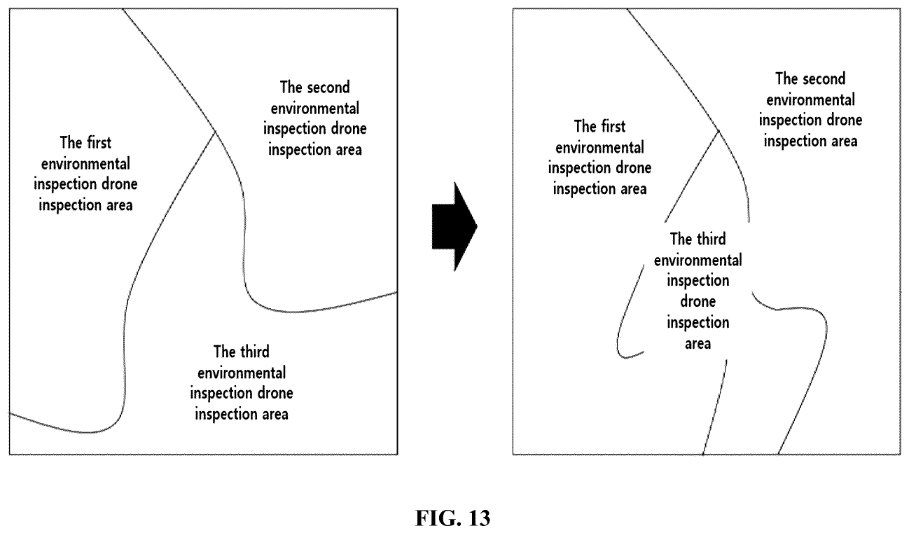

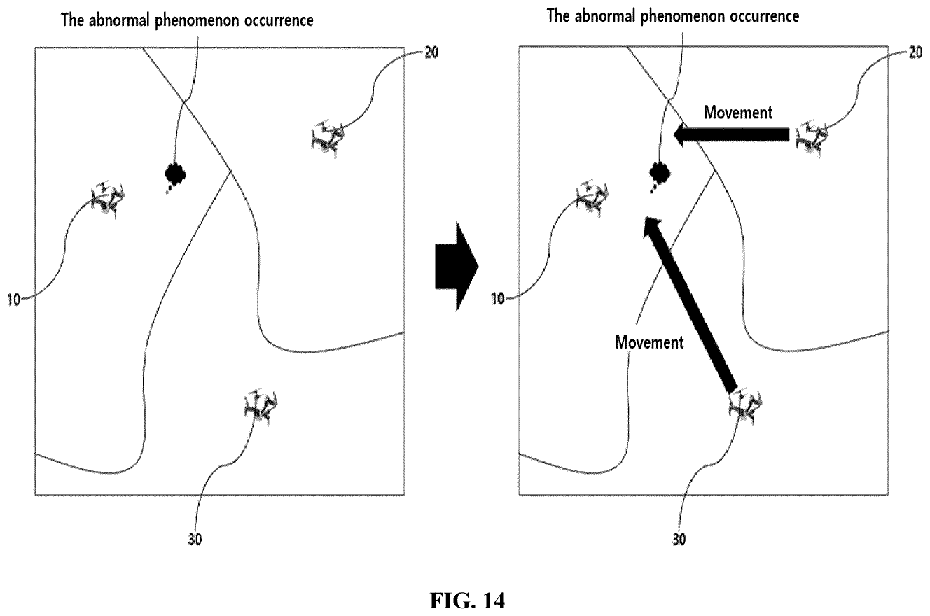

FIG. 11 is a drawing showing an environmental inspection drone according to an embodiment of the present invention setting an inspection movement path to avoid obstacles.

Referring to FIG. 11, the environmental inspection drone (2) may encounter an unexpected obstacle while moving along the set inspection movement path, and modifies the inspection movement path to avoid collision with the obstacle.

When the environmental inspection drone (2) finds an obstacle on the first inspection movement path while moving along the first inspection movement path, it determines that it is impossible to reach the first destination, and searches for and sets an avoidance movement path (e.g., paths a, b, c, etc.) to avoid the obstacle. At this time, the environmental inspection drone (2) selects the shortest avoidance movement path among the obstacle avoidance movement paths that safely avoid the obstacle and returns to the first inspection movement path, which is the original inspection movement path, and moves along the selected shortest avoidance movement path to safely avoid the obstacle and then returns to the first inspection movement path, which is the original inspection movement path.

FIG. 12 is a drawing showing in detail how an environmental inspection drone sets an inspection movement path to avoid obstacles according to an embodiment of the present invention.

Referring to FIG. 12, the inspection movement path setting unit (190) of the environmental inspection drone (2) uses multiple nodes to safely avoid obstacles and sets the shortest avoidance movement path to return to the original inspection movement path (first inspection movement path).

When the sensor unit (145) of the environmental inspection drone (2) detects an obstacle, the inspection movement path setting unit (190) draws a virtual circle (in the case of two dimensions) or a sphere (in the case of three dimensions) formed with a radius of a certain length from the point where the environmental inspection drone (2) is located to set an avoidance movement path to avoid the obstacle, and selects a linear movement path that is closest to the original inspection movement path (first inspection movement path) at the point where the linear movement path and the perimeter of the virtual circle (in the case of two dimensions) or sphere (in the case of three dimensions) intersect among a plurality of preliminary linear movement paths from the point where the environmental inspection drone (2) is located to the perimeter of the virtual circle (in the case of two dimensions) or sphere (in the case of three dimensions), and sets the point where the selected linear movement path and the perimeter of the virtual circle or sphere intersect as the first node, and the environmental inspection drone (2) moves to the first node.

In the same manner as described above, the second node, the third node, and more nodes are set, and the environmental inspection drone (2) moves continuously to the set nodes, and finally safely avoids the obstacle, and then returns to the original inspection movement path (the first inspection movement path). In addition, from the time when avoiding the obstacle begins to the time when returning, it avoids the obstacle and moves along the shortest path to return to the original inspection movement path (the first inspection movement path).

At this time, the radius length of the virtual circle (in case of two dimensions) or sphere (in case of three dimensions) formed at each node is all constant, but the radius length can be adjusted depending on the state of the obstacle. That is, if the exterior of the obstacle is regularly formed, such as a building (if the exterior is formed with a constant rule without curves), the radius length can be made long, and if the exterior of the obstacle is irregularly formed, such as a tree (if the exterior is formed with severe irregular curves), the radius length can be made short. By setting the radius length of the virtual circle (in case of two dimensions) or sphere (in case of three dimensions) formed at each node short, the evasion movement path can be set more precisely.

In addition, when the environmental inspection drone (2) enters an irregular area from an area where the appearance of obstacles is regularly formed while moving, the length of the radius can be changed from being set long to being set short (accordingly, the length between nodes also changes from being long to being short), and when it enters an area where the appearance of obstacles is irregular to being set regular, the length of the radius can be changed from being set short to being set long (accordingly, the length between nodes also changes from being short to being long).

FIG. 13 is a drawing showing a drone modifying an inspection area and an inspection movement path according to the inspection progress status of another drone according to one embodiment of the present invention.

Referring to FIG. 13, multiple environmental inspection drones (2) share data such as their own locations, inspection areas, inspection movement paths, inspection progress rates, battery status, surrounding obstacle status, and surrounding weather conditions with the central control center (1) or other environmental inspection drones (2). Through this, multiple environmental inspection drones (2) can share situations related to inspection tasks with other environmental inspection drones (2), and proceed with the remaining inspection tasks in cooperation with each other according to the situations related to the shared inspection tasks. By proceeding with the remaining inspection tasks in cooperation with each other, the inspection tasks can be performed efficiently and the inspection time can be shortened.

For example, the first and second environmental inspection drones (10, 20) can share with the third environmental inspection drone (30) information that they have completed about 70% of their inspection areas. The third environmental inspection drone (30) can share with the first and second environmental inspection drones (10, 20) information that they have completed about 30% of their inspection areas because the surrounding weather conditions are bad and there are many obstacles in the surroundings (the inspection start times of the first, second, and third environmental inspection drones (10, 20, 30) are the same).

At this time, considering that the inspection progress of the third environmental inspection drone (30) is relatively slow, the first and second environmental inspection drones (10, 20) can each divide the inspection area of the third environmental inspection drone (30) that has not been inspected and conduct the inspection.

First, the first environmental inspection drone (10) sets the inspection area to be inspected in the inspection area where the inspection has not been performed, considering its battery status. After the first environmental inspection drone (10) sets the inspection area to be inspected, the second environmental inspection drone (20) sets its inspection area for the remaining inspection areas not set by the first environmental inspection drone (10), considering its battery status. If there is an inspection area where the inspection has not been performed even though the first and second environmental inspection drones (10, 20) have set the inspection area, the central control center (1) can remember the inspection area where the inspection has not been performed and have the third environmental inspection drone (30) inspect the area first when the next inspection is performed.

Meanwhile, the first and second environmental inspection drones (10, 20) re-establish inspection points and inspection movement paths including an expanded inspection area from the initial inspection area as described in FIG. 8.

In addition, as described in FIG. 10, it is possible to selectively inspect without inspecting all of the set inspection points considering one's battery status. That is, if there are 10 set inspection points, inspection is performed at points 1, 3, 5, 7, and 9, and inspection is not performed at points 2, 4, 6, 8, and 10, so that inspection and non-inspection can be performed alternately.

In addition, depending on the battery situation, the number of uninspected points can be increased selectively. For example, the inspection point can be one point and the uninspected points can be two consecutive points, so that inspection and uninspection can be performed alternately.

FIG. 14 is a drawing showing a plurality of environmental inspection drones collaborating to check for an abnormality according to an embodiment of the present invention. Referring to FIG. 14, when a first environmental inspection drone (10) detects an abnormality while conducting an inspection in its environmental inspection area, the second and third drones (20, 30) move to the area where the first environmental inspection drone (10) detected the abnormality and can collaborate to check for the abnormality.

For example, the first environmental inspection drone (10) flies along a set path and collects data through sensors. When the first drone inspects the atmospheric environment, it monitors the state of the atmosphere using an atmospheric sensor. At this time, when the first environmental inspection drone (10) detects abnormal data (e.g., when the air quality value detected by the atmospheric sensor in a specific area is higher than a preset reference value), it determines that an abnormality has occurred in the atmosphere of that specific area.

The first environmental inspection drone (10) immediately sends a warning signal to the central control center (1) and the second and third drones (20, 30) and transmits the coordinates of the location where the abnormality occurred. At this time, a request for support is automatically sent to the second and third drones (20, 30).

The second and third drones (20, 30) move to the location of the abnormality detected by the first environmental inspection drone (10) and reconfirm the judgment of the occurrence of an abnormality in the atmosphere of a specific area by the first environmental inspection drone (10). To this end, the second and third drones (20, 30) may be equipped with multiple sensors including a precision camera sensor, thereby enabling more precise inspections to be performed. The data collected by the second and third drones (20, 30) are transmitted to the central control center (1) in real time, and the central control center (1) determines whether the abnormality detected by the first environmental inspection drone (10) is real and how serious it is.

Although the present invention has been described with reference to the above embodiments, it will be understood by those skilled in the art that various modifications and changes can be made to the present invention without departing from the spirit and scope of the present invention as set forth in the claims below.

### Description of the sign

1: Central control center
2: Environmental inspection drone
10: First environmental inspection drone
20: Second environmental inspection drone
30: Third environmental inspection drone
40: Camera sensor
41: First support
42: Second support
43: Lens
A1: First environmental inspection drone inspection area
A2: Second environmental inspection drone inspection area
A3: Third environmental inspection drone inspection area
100: Drone server for environmental inspection
110: Input unit
120: Output unit
130: Communication unit
140: Storage unit
145: Sensor unit
150: Control unit
160: Memory unit
170: Position measurement unit
180: Inspection area setting unit
190: Inspection movement path setting unit
200: Inspection movement path storage unit

1. A drone server for environmental inspection, which is installed on an environmental inspection drone, and includes:
an input unit for inputting external information into the server;
an output unit for outputting information inside the server to the outside;
a communication unit for communicating internal and external information of the server;
a storage unit for storing information generated from the server;
a sensor unit for detecting information inside and outside the server;
a control unit for controlling all operations of the server; and a memory unit for executing various programs and storing data accompanying them, wherein:
the memory unit includes a location measuring unit for measuring the location of the environmental inspection drone, an inspection area setting unit for setting an inspection area of the environmental inspection drone, an inspection movement path setting unit for setting an inspection movement path of the environmental inspection drone, and an inspection movement path storage unit for storing the inspection movement path set by the inspection movement path setting unit.

2. The drone server for environmental inspection according to claim 1,
wherein the location information of the environmental inspection drone, measured by the position measurement unit, includes GPS coordinates comprising latitude and longitude coordinates, and altitude coordinates.

3. The drone server for environmental inspection according to claim 1,
wherein the inspection area setting unit sets the environmental inspection area by considering at least one of the battery status of the environmental inspection drone, surrounding terrain conditions, nearby obstacles, or weather conditions.

4. The drone server for environmental inspection according to claim 3,
wherein the inspection area setting unit determines the maximum flight duration by considering the battery status of the environmental inspection drone, calculates the maximum possible travel distance based on the remaining flight time after deducting the time required for return, and sets a three-dimensional virtual sphere with a radius equal to the maximum possible travel distance as the initial environmental inspection area of the environmental inspection drone.

5. The drone server for environmental inspection according to claim 4,
wherein the inspection area setting unit, upon setting the initial inspection area of the environmental inspection drone, adjusts the initial inspection area by considering at least one of the surrounding terrain conditions, nearby obstacles, or weather conditions, thereby determining the final inspection area.

6. The drone server for environmental inspection according to claim 5,
wherein the inspection area setting unit, during the (n)th environmental inspection, reincludes an excluded inspection area in the inspection area of the (n)th environmental inspection when the previously deteriorated weather conditions improve.

7. The drone server for environmental inspection according to claim 6,
wherein the inspection area setting unit, during the (n+1)th environmental inspection, reincludes an inspection area that was previously excluded in the (n)th environmental inspection due to deteriorated weather conditions, when the weather conditions improve.

8. The drone server for environmental inspection according to claim 1,
wherein, when the sensor unit detects an obstacle while the environmental inspection drone is performing an inspection task along a predefined inspection movement path, the inspection movement path setting unit establishes the shortest avoidance movement path that allows the environmental inspection drone to bypass the obstacle and then return to the predefined inspection movement path.

9. The drone server for environmental inspection according to claim 8, wherein the inspection movement path setting unit draws a virtual circle or sphere formed with a radius of a predetermined length at a point where the environmental inspection drone is located, selects a linear movement path whose point where the linear movement path and the circumference of the virtual circle or sphere intersect is closest to the preset inspection movement path among a plurality of preliminary linear movement paths up to the circumference of the virtual circle or sphere, sets the point where the selected closest linear movement path and the circumference of the virtual circle or sphere intersect as a first node, and the environmental inspection drone moves to the preset first node, and thereafter, the inspection movement path setting unit continuously sets nodes in the same manner as the first node is set, and the environmental inspection drone continuously moves to the preset nodes to avoid the obstacle and then sets the shortest avoidance movement path to return to the preset inspection movement path. A drone server for environmental inspection.

10. A plurality of environmental inspection drones, each equipped with a drone server for environmental inspection, wherein the drone server comprises:
an input unit for inputting external information into the server;
an output unit for outputting information inside the server to the outside;
a communication unit for communicating internal and external information of the server;
a storage unit for storing information generated from the server;
a sensor unit for detecting information inside and outside the server;
a control unit for controlling all operations of the server; and a memory unit for executing various programs and storing data accompanying them, wherein:
the memory unit includes a location measuring unit for measuring the location of the environmental inspection drone, an inspection area setting unit for setting an inspection area of the environmental inspection drone, an inspection movement path setting unit for setting an inspection movement path of the environmental inspection drone, and an inspection movement path storage unit for storing the inspection movement path set by the inspection movement path setting unit,
wherein a first environmental inspection drone sets an environmental inspection area by considering the battery status, surrounding terrain status, surrounding obstacle status, or surrounding weather status of the first environmental inspection drone detected by the sensor unit, and a second environmental inspection drone among the plurality of environmental inspection drones sets an inspection area by considering the battery status, surrounding terrain status, surrounding obstacle status, or surrounding weather status of the second environmental inspection drone excluding the inspection area set by the first environmental inspection drone, and among the plurality of environmental inspection drones, the remaining environmental inspection drones excluding the first and second environmental inspection drones sequentially set inspection areas in the same manner as the first and second environmental inspection drones set their inspection areas.

11. The plurality of environmental inspection drones according to claim 10,
wherein the inspection area setting unit of the first environmental inspection drone determines the maximum flight duration based on the battery status of the first environmental inspection drone, calculates the maximum possible travel distance by excluding the time required for returning from the maximum flight duration, and sets a three-dimensional virtual sphere with a radius equal to the maximum travel distance as the initial environmental inspection area of the first environmental inspection drone.

12. The plurality of environmental inspection drones according to claim 11,
wherein, once the initial inspection area of the first environmental inspection drone is set, the inspection area setting unit of the first environmental inspection drone adjusts the initial inspection area by considering at least one of the surrounding terrain conditions, nearby obstacles, or weather conditions, thereby determining the final inspection area of the first environmental inspection drone.

13. The plurality of environmental inspection drones according to claim 12,
wherein the inspection area setting unit of the second environmental inspection drone determines the maximum flight duration based on the battery status of the second environmental inspection drone, calculates the maximum possible travel distance by excluding the time required for returning from the maximum flight duration, and sets a three-dimensional virtual sphere with a radius equal to the maximum travel distance as the initial inspection area of the second environmental inspection drone, and wherein, once the initial inspection area of the second environmental inspection drone is set, the final inspection area of the first environmental inspection drone is excluded, and the inspection area setting unit of the second environmental inspection drone adjusts the initial inspection area by considering at least one of the surrounding terrain conditions, nearby obstacles, or weather conditions, thereby determining the final inspection area of the second environmental inspection drone.

14. The plurality of environmental inspection drones according to claim 13,
wherein, once the final inspection areas of the first and second environmental inspection drones are set, the remaining environmental inspection drones, excluding the first and second environmental inspection drones, sequentially determine their final inspection areas in the same manner as the first and second environmental inspection drones.

15. The plurality of environmental inspection drones according to claim 14,
wherein, if there remain unassigned inspection areas after all inspection areas have been set by the plurality of environmental inspection drones, the central control center designates a specific environmental inspection drone among the plurality of environmental inspection drones to inspect the unassigned inspection area.

16. The plurality of environmental inspection drones according to claim 10,
wherein, if an emergency situation occurs in the first environmental inspection drone, rendering it unable to continue the environmental inspection task, the central control center designates one environmental inspection drone among the remaining plurality of environmental inspection drones, excluding the first environmental inspection drone, to take over and continue performing the environmental inspection task previously assigned to the first environmental inspection drone.

17. The plurality of environmental inspection drones according to claim 10,
wherein, if the first environmental inspection drone detects an anomalous phenomenon while performing an inspection task, the remaining plurality of environmental inspection drones, excluding the first environmental inspection drone, move to the area where the anomaly occurred and collaborate to verify the anomalous phenomenon.

18. The plurality of environmental inspection drones according to claim 10,
wherein the plurality of environmental inspection drones and the central control center are integrated into a network, enabling mutual information sharing.

19. A drone server for environmental inspection, which is installed on an environmental inspection drone, and includes:
an input unit for inputting external information into the server;
an output unit for outputting information inside the server to the outside;
a communication unit for communicating internal and external information of the server;
a storage unit for storing information generated from the server;
a sensor unit for detecting information inside and outside the server;
a control unit for controlling all operations of the server; and a memory unit for executing various programs and storing data accompanying them, wherein:
the memory unit includes a location measuring unit for measuring the location of the environmental inspection drone, an inspection area setting unit for setting an inspection area of the environmental inspection drone, an inspection movement path setting unit for setting an inspection movement path of the environmental inspection drone, and an inspection movement path storage unit for storing the inspection movement path set by the inspection movement path setting unit
wherein the memory unit comprises a position measurement unit for determining the location of the environmental inspection drone, an inspection area setting unit for defining the inspection area, an inspection movement path setting unit for establishing the inspection movement path, and an inspection movement path storage unit for storing the set inspection movement path, and
wherein the inspection area setting unit determines the maximum possible inspection area at a specific location by utilizing the field of view (FOV) and maximum visible distance of the camera sensor included in the sensor unit, a 360-degree rotation angle based on the vertical central axis, and an upward and downward tilt angle based on the horizontal central axis of the environmental inspection drone.

20. The drone server for environmental inspection according to claim 19,
wherein the camera sensor comprises a first support unit, a second support unit, and a lens unit,
wherein the second support unit rotates 360 degrees around a vertical central axis, and the lens unit rotates 180 degrees around a horizontal central axis, thereby expanding the maximum possible inspection area of the environmental inspection drone.

21. The drone server for environmental inspection according to claim 19,
wherein the inspection movement path setting unit sets the first inspection point at the center of a virtual circle or sphere formed by connecting the first junction point, where the outermost point of the first maximum possible inspection area and the outermost point of the inspection area set by the inspection area setting unit meet, with the junction point where the outermost points of the first and second maximum possible inspection areas connect, sets the second inspection point at the center of a virtual circle or sphere formed by connecting the second junction point, where the outermost point of the second maximum possible inspection area and the outermost point of the inspection area set by the inspection area setting unit meet, with the junction point where the outermost points of the first and second maximum possible inspection areas connect, continuously sets additional inspection points in the same manner as the first and second inspection points, and connects these sequentially set inspection points to establish the inspection movement path.

22. The drone server for environmental inspection according to claim 21,
wherein the inspection movement path setting unit sets an intermediate point between adjacent inspection points among the set inspection points as a new inspection point.

23. The drone server for environmental inspection according to claim 22,
wherein, during the (n)th inspection, the environmental inspection drone performs the inspection task while excluding the newly set inspection points located at the midpoints between adjacent inspection points, during the (n+1)th inspection, the environmental inspection drone performs the inspection task while including the newly set midpoint inspection points, and for subsequent inspections after the (n+1)th inspection, the environmental inspection drone alternates between inspecting the (n)th inspection points and the (n+1)th inspection points.

24. The drone server for environmental inspection according to claim 22,
wherein, if the environmental inspection drone has insufficient battery, encounters unfavorable weather conditions, or detects an obstacle, it performs the inspection task while excluding the newly set inspection points located at the midpoints between adjacent inspection points.
